(19) United States
(12) Patent Application Publication
(10) Pub. No.: US 2007/0022602 A1
(43) Pub. Date: Feb. 1, 2007

(54) Forming conductive traces

(76) Inventors: Howard A. Kingsford, Amherst, NH (US); William P. Clune, Hillsborough, NH (US); Kristel Ferry, Methuen, MA (US)

Correspondence Address: FISH & RICHARDSON PC, P.O. BOX 1022, MINNEAPOLIS, MN, 55440-1022, US

(21) Appl. No.: 11/495,045

(22) Filed: Jul. 28, 2006

Related U.S. Application Data
(60) Provisional application No. 60/703,331, filed on Jul. 28, 2005.

(51) Int. Cl. H01K 3/22

(52) U.S. Cl. 29/848; 29/831

(57) ABSTRACT

A method of forming a flexible conductive strip includes: molding a continuous, flexible base of an electrically insulating thermoplastic resin, while forming channels in a surface of the base; at least partially filling the formed channels with a flowable, electrically conductive composition; and then stabilizing the flowable composition in the channels to form a pattern of stable, electrically conductive traces within the channels. A method of forming a flexible circuit board having loop-engageable touch fastener elements includes: molding a continuous, flexible base from an electrically insulating thermoplastic resin, while forming a field of stems integrally molded with and extending from a first side of the base; applying a conductive material to the base to form a pattern of electrically conductive traces in accordance with a circuit design; and forming loop-engageable heads on the stems.

### CROSS REFERENCE TO RELATED APPLICATIONS

This application claims the benefit of U.S. Provisional Patent Application No. 60/703,331, filed Jul. 28, 2005, which is incorporated herein by reference in its entirety.

### TECHNICAL FIELD

This invention relates to flexible circuits, and more particularly to methods of forming flexible circuits.

### BACKGROUND

The increased use of electrical wires, cables and circuits has resulted in an increased need for efficient and inexpensive means for production of flexible substrates carrying conductive circuit traces, and controllably directing and securing such circuits to avoid, damage, wear, and inadvertent disconnection. Touch fasteners have been suggested as one means of securing such flexible conductive regions on a substrate having circuits, for example.

One approach to producing flexible substrates with conductive circuit traces features using printing technologies to apply conductive material to a flexible substrate.

One approach to forming conductive regions on a substrate having touch fasteners features selectively metallizing portions of a surface covered with touch fasteners. Another approach features feeding continuous conductors into a roll molding apparatus with molten resin, such that the conductors become encapsulated in a resin base molded to have touch fastener elements extending from its outer surface.

### SUMMARY

In one aspect of the invention, a method of forming a flexible conductive strip includes: molding a continuous, flexible base of an electrically insulating thermoplastic resin, while forming channels in a surface of the base; at least partially filling the formed channels with a flowable, electrically conductive composition; and then stabilizing the flowable composition in the channels to form a pattern of stable, electrically conductive traces within the channels.

In another aspect of the invention, a method of forming a releasably securable, flexible conductive strip includes: molding a continuous, flexible base of an electrically insulating thermoplastic resin, while forming channels in a surface of the base; at least partially filling the formed channels with a flowable, electrically conductive composition; stabilizing the composition in the channels to form a pattern of stable, electrically conductive traces within the channels; and providing a field of loop-engageable fastener elements on the base and exposed to releasably secure the base to a loop-bearing support.

In another aspect of the invention, a method of forming a flexible circuit includes: molding a continuous, flexible base of an electrically insulating thermoplastic resin, while forming channels in a surface of the base; at least partially filling the formed channels with a flowable, electrically conductive composition; stabilizing the composition in the channels to form a pattern of stable, electrically conductive traces within the channels; providing a field of loop-engageable fastener elements on the base and exposed to releasably secured the base to loop-bearing support; and securing at least one discrete electrical component to the surface of the base, such that the electrical components electrically interconnect a plurality of the traces.

In another aspect of the invention, a method of forming a flexible circuit board having loop-engageable touch fastener elements includes: molding a continuous, flexible base from an electrically insulating thermoplastic resin, while forming a field of stems integrally molded with and extending from a first side of the base; applying a conductive material to the base to form a pattern of electrically conductive traces in accordance with the circuit design; and forming loop-engageable heads on the stems.

In some embodiments, at least partially filling the formed channels comprises using printing techniques to dispense conductive ink into the channels. In some other embodiments, at least partially filling the formed channels comprises dispensing the flowable composition onto the surface of the base, and then substantially removing the flowable composition from non-channel regions of the surface. In some cases, removing the flowable composition comprises wiping the surface.

In some embodiments, the flowable composition is in powder form prior to stabilization. In some other embodiments, the flowable composition comprises a liquid carrier solution containing metal ions. In some cases, the flowable composition comprises a suspension of metal particles.

In some embodiments, the composition is stabilized in the channels by evaporating a solvent from the composition. In some other embodiments, the composition is stabilized by radiating the composition in the channels with radiation selected from a group consisting of heat, ultraviolet radiation, and microwave radiation. In some cases, the flowable composition is stabilized by subjecting the composition to reducing conditions. In some embodiments, the flowable composition is stabilized by releasing reducing agents from capsules contained within the flowable composition.

In some embodiments, molding the base comprises feeding the thermoplastic resin in a moldable form into a gap adjacent a mold roll. In some cases, the gap is defined between the mold roll and a counter-rotating roll. In some cases, methods also include forming a field of loop-engageable fastener elements extending from the base by: introducing the resin into the gap such that the resin fills a field of fixed cavities defined in the mold roll to form a field of molded stems; solidifying the molded stems; stripping the stems from the mold roll; and forming loop-engageable heads on the molded stems.

In some embodiments, molding the channels comprises employing a mold roll that defines headed features in the surface of the channels for mechanically locking the flowable composition in the channels when it stabilizes. In some cases, the channels are formed with varying depths such that the resulting conductive traces are of varying thicknesses. Similarly, in some cases, the channels are formed with varying widths such that the resulting conductive traces are of varying widths.

In some embodiments, methods also include surface-treating the channels to promote adhesion of the flowable composition prior to filling the channels.

In some embodiments, methods also include providing a field of loop-engageable fastener elements on the base exposed to releasably secure the base to a loop-bearing support. In some cases, providing the fastener elements comprises integrally molding the fastener elements with the base such that the fastener elements extend outwards from a surface of the base. In some other cases, providing the fastener elements comprises attaching fastener elements to the base.

In some embodiments, forming the channels comprises forming the channels with at least a portion whose width decreases with increasing distance from the resin base.

In some embodiments, the pattern of electrically conductive traces is longitudinally continuous and arranged such that, when the base is severed to create individual strips of a desired, finite length between severed ends, the electrically conductive traces provide an electrical connection between the severed ends. In some cases, methods also include forming touch fastener elements exposed along the length of the base and arranged such that the individual strips each have some of the touch fastener elements exposed for releasably mounting the strip to a support surface.

In some embodiments, the pattern of electrically conductive traces form interconnected path segments arranged in accordance with a desired circuit pattern.

In some embodiments, methods also include electroplating a second conductive material onto the conductive traces.

In some embodiments, methods also include attaching an electrically insulating cover over the conductive traces, the cover attached to the base. In some cases, attaching the insulative layer comprises passing the sheet-form base through a gap adjacent a mold roll in the presence of moldable resin to encapsulate the conductive traces. In some other cases, attaching the insulative cover comprises spraying an insulating composition onto the base, such that the insulating composition encapsulates the conductive traces.

In some embodiments, the flowable composition contains silver. In some cases, the silver composition is a reducible silver composition.

Methods of the present invention provide an efficient approach to forming conductive traces on a flexible backing. Such methods can rapidly produce large amounts of longitudinally continuous substrate carrying flexible circuits. In addition, by focusing the application of conductive material to desired locations on the substrate, these methods can limit the use of conductive material.

Forming channels in the substrate allows for more control in the placement of the conductive traces. It also provides a convenient means of varying the thickness as well as the width of the conductive traces. As the current carrying ability of the conductor is proportional to its cross-section, this provides an efficient method of varying the current carrying ability of the conductive traces while conserving surface space on the substrate. This approach also can save time and avoided registration problems because, in some configurations, it only requires one pass, rather than multiple passes, of the device dispensing the conductive material.

Flexible conductive hook fastener substrates can be efficiently and continuously formed with integral hook fastener elements according to certain methods and apparatus of the invention. These techniques allow for electrical conductivity along the substrate in a patterned arrangement, on one or more surfaces, and/or on the hook fastener members themselves, as desired. Furthermore, the resulting conductive hook fastener substrates provide a surface on which other electrical components can be attached to process, relay, or modify electrical signals carried along the substrate.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic side view of the manufacturing system used to produce a flexible circuit.

FIG. 1A is a cross-sectional view of the nip of the manufacturing system shown in FIG. 1.

FIG. 1B is a cross-sectional view of the flexible circuit shown in FIG. 1, taken along the circuit's centerline, before conductive traces are added.

FIG. 1C is a cross-sectional view of the flexible circuit shown in FIG. 1, taken along the circuit's centerline, after conductive traces are added.

FIG. 1D is a cross-sectional view taken into the nip of the manufacturing system shown in FIG. 1.

FIGS. 2A and 2B are perspective views of alternate embodiments of circuit patterns formed by the manufacturing system shown in FIG. 1.

FIGS. 3-5 are schematic views of alternate embodiments of the manufacturing system shown in FIG. 1.

FIG. 5A is a cross-sectional view of the flexible circuit shown in FIG. 5, taken along the circuit's centerline, before and after the head of the stem is deformed.

FIG. 6 is a schematic view of another alternate embodiment of the manufacturing system shown in FIG. 1.

Like reference symbols in the various drawings indicate like elements. The drawings are not to scale as the dimensions of various features shown in the drawings have been adjusted for clarity of illustration.

### DETAILED DESCRIPTION

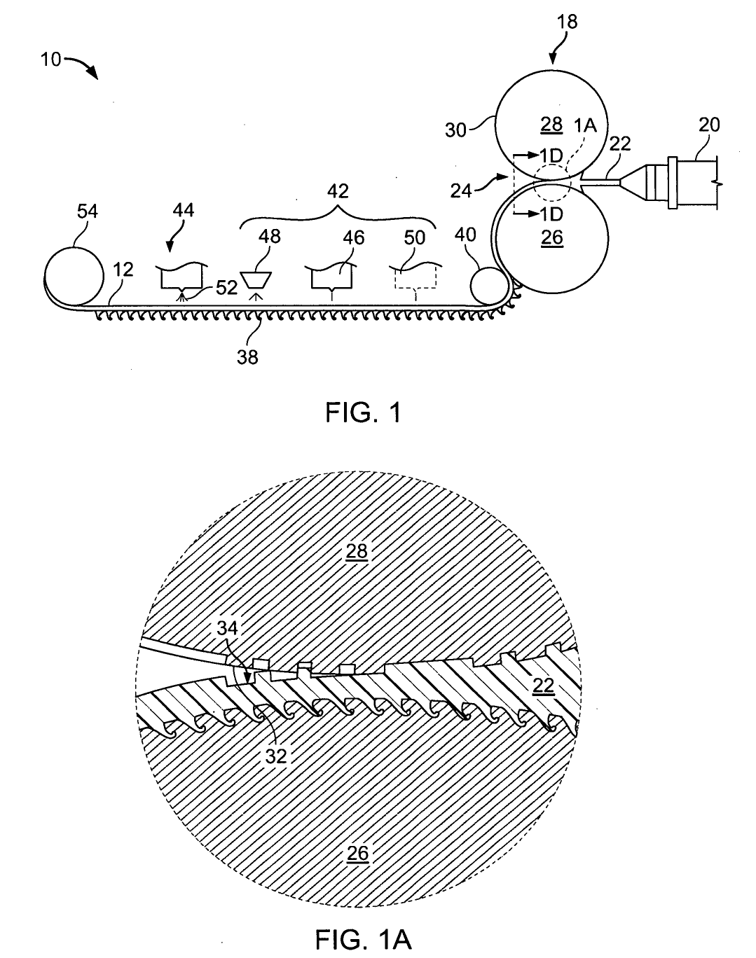

Referring to FIGS. 1-1D, a manufacturing method and system 10 produces a flexible circuit 12 with a thermoplastic resin base 14 that carries a pattern of conductive traces 16. Manufacturing system 10 includes a forming or roll molding apparatus 18 of the general type shown in U.S. Pat. No. 4,872,243 issued to Fisher. An extruder 20 feeds molten resin 22 into a nip 24 defined between a mold roll 26 and a counter-rotating second mold roll 28. An outer surface 30 of second mold roll 28 includes structural features 32 configured to shape shallow channels 34 in resin base 14. Mold roll 26 has a field of small mold cavities 36 extending into its peripheral surface. Each mold cavity 36 is shaped to form a loop-engageable hook 38.

In this embodiment, structural features 32 that form channels 34 are configured to form heads 116 extending from resin base 14 into the channels. Heads 116 are symmetrical stems whose cylindrical outer surface has a circumference that increases with increasing distance from resin base 14. This tapering effect allows flowable conductive material filling channels 34 to surround heads 116 while providing a mechanical resistance to the removal of conductive traces 16 from resin base 14 after the conductive material is stabilized to form the conductive traces. In other embodiments, heads 116 are configured as hooks or as longitudinally-extending ridges. In still other embodiments, no heads are present in channels 34.

Structural features 32 are also configured to form channels 34 whose opening is narrower than the width of the base of the channel. Some other embodiments form channels 34 with different shapes. However, channels 34 with at least a portion whose width decreases with increasing distance from resin base 14 provide additional mechanical resistance to the removal of conductive traces 16 from the resin base after stabilization.

Channels 34 are formed with varying widths and thicknesses. Consequently, conductive traces 16 also have varying widths and thicknesses whose dimensions are selected based on the desired current carrying ability of specific regions of the conductive traces. As the current carrying ability of conductors is proportional to their cross-sections, this provides an efficient method of varying the current carrying ability of the conductive traces while conserving surface space on the substrate. This approach also can save time and avoided registration problems because it only requires one pass, rather than multiple passes, of the device dispensing the conductive material.

In this embodiment, second mold roll 28 is formed of a roller sleeve whose surface is etched to form structural features 32. Alternatively, second mold roll 28 can be assembled from multiple rings, each ring including structural features 32 configured to shape shallow channels 34. The use of roll molding produces channels 34 in longitudinally extending repeating patterns. Multiple flexible circuits 12 with longitudinally-extending patterns of channels 34 can be produced side-by-side on a single roll molding apparatus 18. In some embodiments, these multiple flexible circuits 12 are separated from each other as part of manufacturing process. In other embodiments, these multiple flexible circuits 12 are produced in a longitudinally-extending sheet for later separation.

As molten resin 22 enters nip 24, pressure in the nip forces the resin into mold cavities 36 and around structural features 32. After passing through nip 24, resin 22 continues on the surface of rotating temperature-controlled (cooled) mold roll 26 until the resin is sufficiently cooled to enable removal from the mold roll by a stripping roll 40. In this embodiment, hooks 38 are integrally molded with base 14 and extend in a longitudinally extending band from a side opposite the side of the base which defines channels 34. In use, hooks 38 can be used to releasably secure base 14 to a loop-bearing support 39 (see FIG. 1C).

In other embodiments, other loop-engageable or self-engageable fastener elements may be molded on resin base 14. Hooks 38 or other fastener elements may be arranged in discrete islands of fastener elements rather than in longitudinally extending bands.

Manufacturing system 10 also includes a filling station 42 and a sealing station 44. Filling station 42 includes an inkjet 46 which dispenses ultraviolet curable conductive ink into channels 34. Ultraviolet emitter 48 radiates ultraviolet light which cures and solidifies the conductive ink in channels 34 to form conductive traces 16. Optionally, a second inkjet 50 dispenses a surface treatment (e.g., a solvent pre-wash, or an adhesive) into channels 34 to prepare the channels to receive the conductive ink.

After conductive traces 16 are formed, sealing station 44 sprays a cover 52 (e.g., an epoxy, an acrylate, or an epoxy-acrylate) on the upper surface of resin base 14. Cover 52 is selected at least in part for its compatibility with and ability to bond to the resin of base 14 and for its insulative properties. Cover 52 and resin base 14 cooperate to substantially insulate conductive traces 16 from each other and from the surrounding environment. The resulting flexible circuit 12 is spooled for storage on storage roll 54.

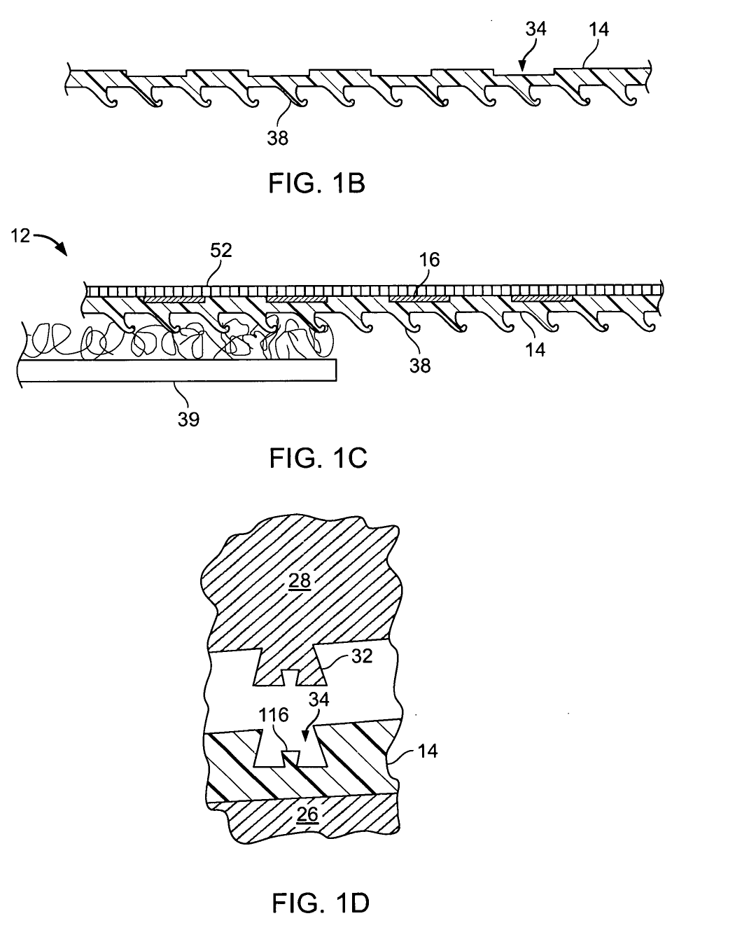

Manufacturing system 10 can form conductive traces 16 in a variety of configurations. In one example, an embodiment of mold roll 28 includes structural features 32 arranged to form conductive traces 16 as interconnected path segments arranged in accordance with a desired circuit pattern, as shown in FIG. 2A, for receiving six-pin light emitting diodes. In another example, another embodiment of mold roll 28 includes structural features 32 arranged to form conductive traces 16 as two parallel strips, as shown in FIG. 2B. The pattern shown in FIG. 2B also illustrates the flexibility resulting from use of an appropriate thermoplastic resin to form base 14 of flexible circuit 12. Because the conductive traces are arranged in a repeating pattern, the base can be severed between adjacent iterations of the pattern at multiple locations to create circuit strips of a desired finite length. In such embodiments, the conductive traces electrically connect the severed ends of the finite strip to each other and to electrical devices mounted along the length of the strip.

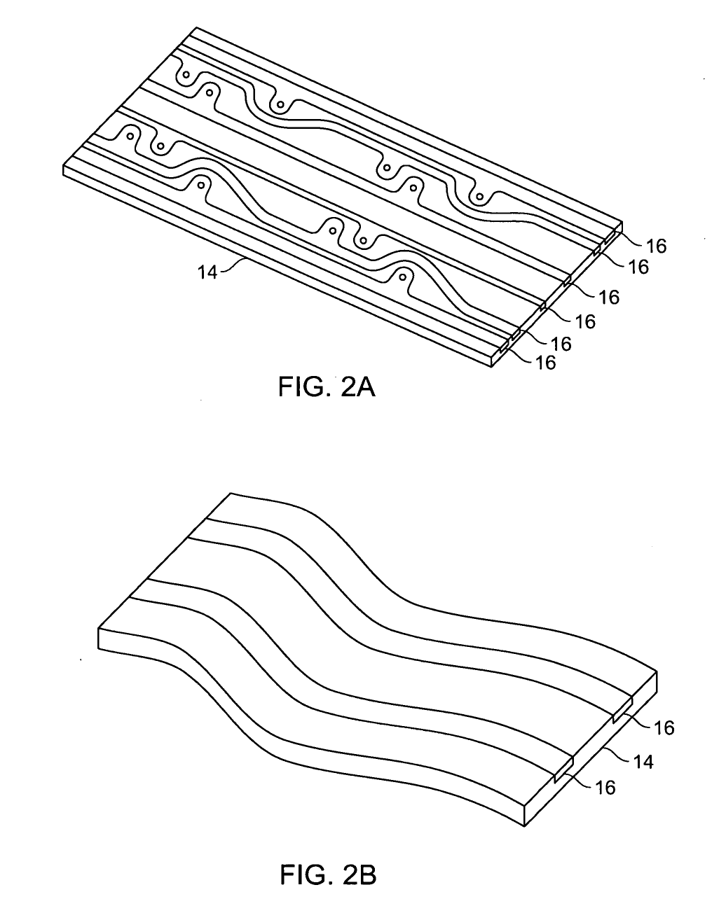

Referring to FIG. 3, in an alternate manufacturing method and system 56, extruder 20 feeds molten resin 22 into nip 24 defined between mold roll 28 and a support roll 58. Resin base 14 is formed in nip 24 and passes to filling station 42A. It is not necessary for the resin 22 to continue on the surface of mold roll 28 or support roll 58 because no hooks are being formed. Consequently, it is not necessary to allow time for roll induced cooling to occur to solidify molded stems or hooks.

Filling station 42A includes a print roll 60 and a doctor blade 62. As base 14 passes between print roll 60 and a second support roll 58, the print roll applies a quick-drying conductive ink 64 to the upper surface of resin base 14. Conductive ink 64 fills channels 34 and accumulates on the face of resin base 14. Doctor blade 62 wipes accumulated ink 64 from the face of resin base 14 while leaving ink in channels 34 where the ink dries and solidifies to form conductive traces on the resin base as the resin base proceeds past tensioning roll 66 to lamination rolls 68. Optionally, filling station 42A also includes a hot air blower 68 which hastens the stabilization process by heating and ventilating conductive ink 64 to encourage the evaporation of the solvents which keep the ink in liquid form.

Resin base 14 and preformed fastener tape 72 are fed into lamination nip 78 defined between lamination rolls 68. Heater 74 heats fastener tape 72 as the fastener tape proceeds from feed roll 76 into lamination nip 78. Fastener tape 72 is selected from fastener tapes which are compatible with the resin of base 14. Thus, when heated fastener tape 72 proceeds through lamination nip 78 with base 14, the fastener tape and the base cooperate in sealing and insulating conductive traces 16 within the flexible circuit 12′. In other embodiments, an adhesive is applied to fastener tape 72 before it enters lamination nip 78 rather than heating the fastener tape before it enters the lamination nip.

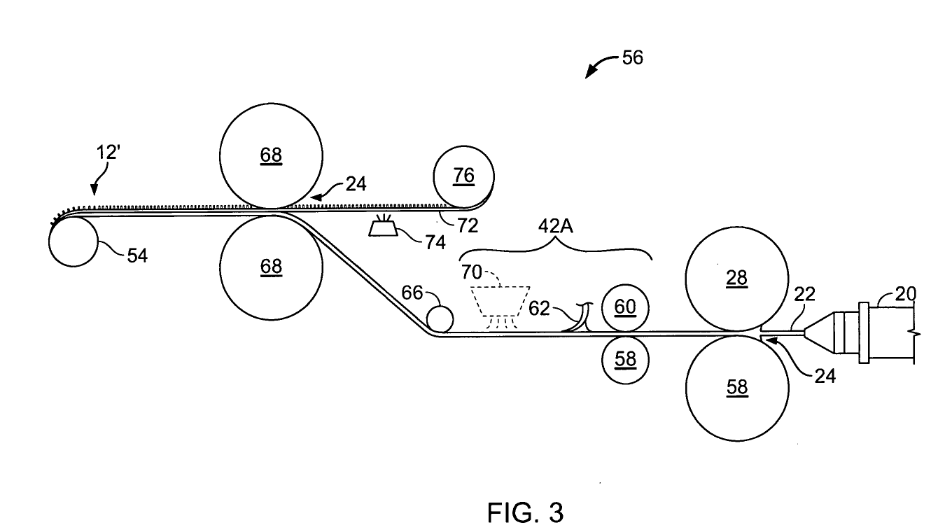

Referring to FIG. 4, another alternate manufacturing method and system 80 forms resin base 14 using a similar approach to that described for manufacturing system 56. However, manufacturing system 80 includes a filling station 42B which fills channels 34 with particles of metallic powder and forms conductive traces 16 by bonding these particles together. In filling station 42B, spray dispenser 82 sprays or otherwise dispenses particles of metallic powder on the upper surface of resin base 14. The particles of metallic powder fill channels 34 and accumulate on the face of resin base 14. Doctor blade 62 wipes accumulated particles from the face of resin base 14 while leaving particles in channels 34. The particles can have various geometries (e.g., angular or spherical) and fill channels 34 with adjacent particles touching at contact points while otherwise leaving interstitial voids between the particles. As resin base 14 passes through a sintering device 84, the sintering device emanates radio-frequency (RF) energy that causes eddy currents to develop within the particles in the channels. These currents cause the contact points between adjacent particles to heat up such that surface melting fuses the adjacent particles together at the contact points and locally melts resin of the channel walls touching the particles, but does not generally increase the density of the powder matrix. The result is an electrically conductive matrix extending along the channel as a trace. The metallic powder is preferably selected from a material (e.g., a tin-bismuth alloy) that has a high electrical conductivity and a low melting point and/or specific heat. Resin base 14 with the stabilized metal forming conductive traces 16 passes through a chiller 86 to cool the metal and, thus, limit melting of the thermoplastic resin base.

In some embodiments, system 80 also includes an electroplating station used to electroplated a second conductive material onto conductive traces 16. This can increase the uniformity of the conductivity along the surface of conductive traces 16 which can be important in some applications including, for example, radio-frequency identification tags.

Manufacturing system 80 installs electrical components (e.g., light emitting diodes) on resin base 14. A component feed roll 88 places light emitting diode devices 90 into receptacles 92 on a placement roll 94, with diode pins 95 directed radially outwards. Optionally, a pin heater 96 is placed to heat pins 95 of light emitting diode devices 90 as placement roll 94 rotates to bring the light emitting diode devices into contact with resin base 14. Pins 95 contact and pierce conductive traces 16 and resin base 14. This provides both electrical connection and mechanical fastening for light emitting diode devices 90. In other embodiments, similar manufacturing systems include mechanisms for forming mounting receptacles on a flexible circuit as is discussed in more detail in “Mounting Electrical Components,” U.S. Patent App. Ser. No. 60/703,330 filed on Jul. 28, 2005, the entire contents of which are incorporated herein by reference.

It can be difficult to spool circuits with electrical components attached. Therefore, manufacturing system 80 includes a cutting roll 98. As circuit 12″ is pulled between cutting roll 98 and support roll 58; ridges 100 arranged on the peripheral surface of the cutting roll cut the longitudinally extending circuit into multiple circuit strips of discrete length. Although this illustrative embodiment does not include fastener elements, some embodiments of cutting rolls 98 include fastener elements. When the fastener elements are formed or provided as a continuous strip extending longitudinally along resin base 14, each discrete circuit strip necessarily includes fastener elements. However, if the fastener elements are formed or provided in islands along resin base 14, the spacing of the islands and the spacing of ridges 100 on cutting roll 98 are chosen such that each discrete circuit strip includes the desired amount of fastener elements.

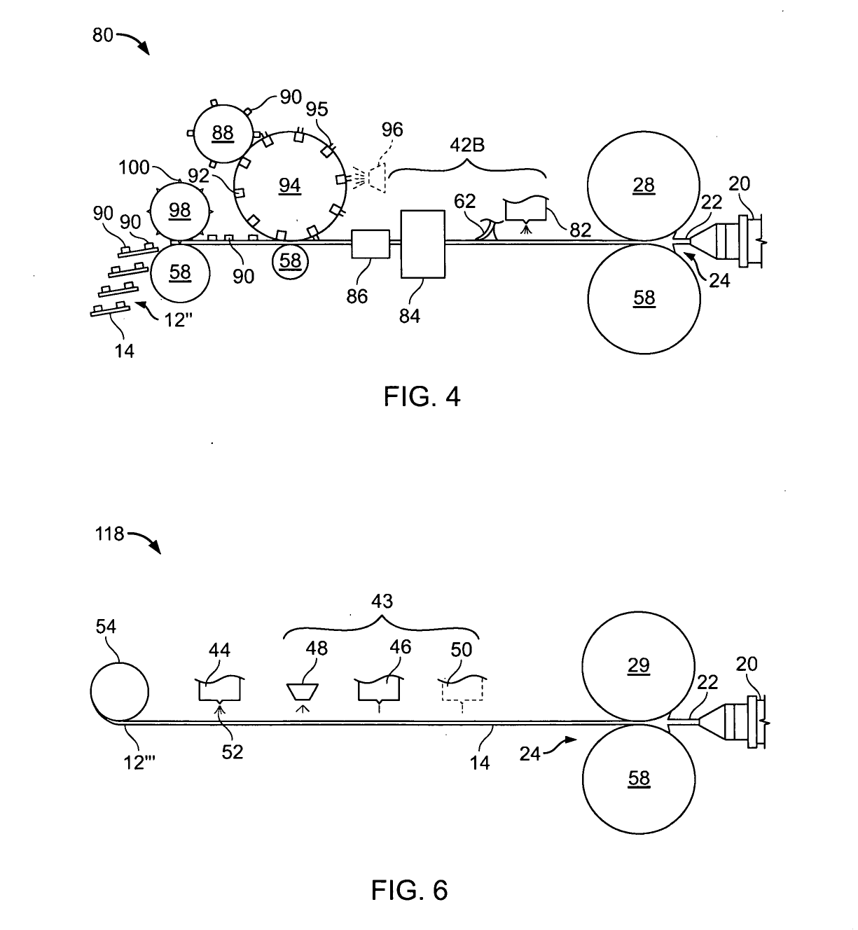

Referring to FIG. 5, another alternate manufacturing method and system 102 forms resin base 14 in a gap 104 defined between extruder 20 and mold roll 28, molding channels in a surface of the base. After stripping roll 40 removes resin base 14 from mold roll 28, dispenser 82 sprays a liquid silver composition 106 (e.g., a binding agent such as ethylenediaminetetraacetic acid (EDTA) or citric acid containing silver ions) on the resin base. The liquid silver composition contains reducing agents (e.g., ascorbic acid or ferrous ammonium sulfate) encapsulated in micro-bubbles. After doctor blade 62 wipes accumulated silver composition from non-channel regions of resin base 14, energy radiated by ultrasonic emitter 108 releases the reducing agents initially contained by the micro-bubbles and solidifies the silver composition. In other embodiments, other liquid compositions of similar properties, including for example compositions with other metals such as copper or aluminum, are used to fill channels 34 and to form conductive traces 16 on resin base 14.

Resin base 14 with conductive traces 16 passes tensioning roll 66 and is fed into nip 24 defined between mold roll 26 and pressure roll 29 with molten resin 22 from a second extruder 20. Mold roll 26 includes fields of mold cavities (not shown) into which molten resin 22 is forced. Resin 22 is selected to be compatible with the resin of base 14 such that passage through nip 24 laminates a resin layer 109 to the base to seal conductive traces 16. Although shown in FIG. 5A as distinct for purposes of illustration, the resin of layer 109 and base 14 can be joined together under conditions that cause the resins to so intimately bond as to become unitary.

The mold cavities in roll 26 form longitudinally-extending bands of molded stems integrally molded with and extending outward from resin layer 109. After stripping roll 40 removes circuit 12 from mold roll 26, stem heater 110 softens stems 38′ such that the application of pressure by flat-topping roll 112 deforms the end of the stems to form loop-engageable heads 114 (FIG. 5A).

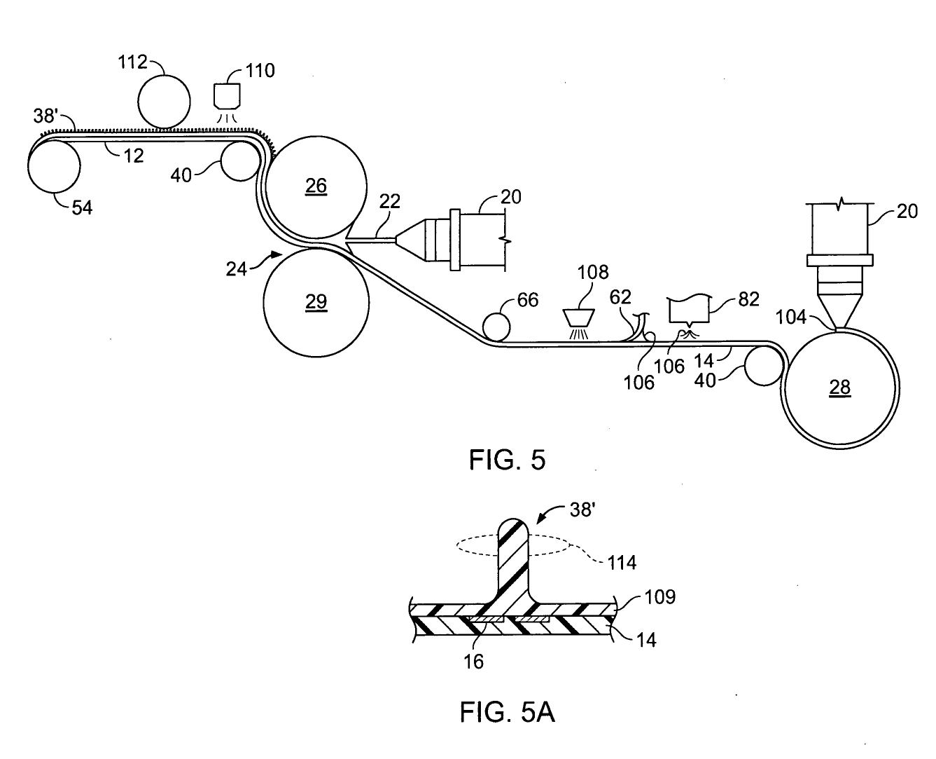

Referring to FIG. 6, in another alternate manufacturing method and system 118, extruder 20 feeds molten resin 22 into nip 24 defined between pressure roll 29 and a support roll 58. Resin base 14, formed in nip 24, does not include channels. Resin base 14 passes from nip 24 to printing station 43 which, like filling station 42, includes inkjet 46, ultraviolet emitter 48, and, optionally, second inkjet 50. Because resin base 14 is channel-less, inkjet 46 dispenses ultraviolet curable conductive ink directly onto the upper surface of the resin base in the pattern of the desired conductive traces. Ultraviolet emitter 48 radiates ultraviolet light which cures and solidifies the conductive ink to form conductive traces (not shown) on the surface of resin base 14. Optionally, a second inkjet 50 dispenses a surface treatment to predispose portions of the surface of resin base 14 to receive the conductive ink. Sealing station 44 and storage roll 54 cover the conductive traces and store on the flexible circuit as described in more detail in the discussion of FIG. 3 above.

The various features and components of the above-described systems may be combined in other ways. For example, another manufacturing system (not shown) features roll-molding apparatus 18 of manufacturing system 10 and filling station 42A and preformed fastener strip sealing of manufacturing system 56 and forms a flexible circuit with fastener elements extending from both opposing sides.

A number of embodiments of the invention have been described. Nevertheless, it will be understood that various modifications may be made without departing from the spirit and scope of the invention. For example, other printing techniques including, for example, spraying conductive material through a mask, could be used for initial formation of the conductive traces. Accordingly, other embodiments are within the scope of the following claims.

What is claimed is:

1. A method of forming a flexible conductive strip, the method comprising:
molding a continuous, flexible base of an electrically insulating thermoplastic resin, while forming channels in a surface of the base;
at least partially filling the formed channels with a flowable, electrically conductive composition; and then
stabilizing the flowable composition in the channels to form a pattern of stable, electrically conductive traces within the channels.

2. The method of claim 1 wherein stabilizing the flowable composition comprises permanently bonding the conductive traces to the resin.

3. The method of claim 1, at least partially filling the formed channels comprises using printing techniques to dispense conductive ink into the channels.

4. The method of claim 1, at least partially filling the formed channels comprises dispensing the flowable composition onto the surface of the base, and then substantially removing the flowable composition from non-channel regions of the surface.

5. The method of claim 4, wherein removing the flowable composition comprises wiping the surface.

6. The method of claim 1, wherein the flowable composition is in powder form prior to stabilization.

7. The method of claim 1, wherein the flowable composition comprises a liquid carrier solution containing metal ions.

8. The method of claim 1, wherein the flowable composition comprises a suspension of metal particles.

9. The method of claim 1, wherein the composition is stabilized in the channels by evaporating a solvent from the composition.

10. The method of claim 1, wherein the composition is stabilized by radiating the composition in the channels with radiation selected from a group consisting of heat, ultraviolet radiation, and microwave radiation.

11. The method of claim 1, wherein the flowable composition is stabilized by subjecting the composition to reducing conditions.

12. The method of claim 1, wherein the flowable composition is stabilized by releasing reducing agents from capsules contained within the flowable composition.

13. The method of claim 1, wherein molding the base comprises feeding the thermoplastic resin in a moldable form into a gap adjacent a mold roll.

14. The method of claim 13, further comprising forming a field of loop-engageable fastener elements extending from the base by:
introducing the resin into the gap such that the resin fills a field of fixed cavities defined in the mold roll to form a field of molded stems;
solidifying the molded stems;
stripping the stems from the mold roll; and
forming loop-engageable heads on the molded stems.

15. The method of claim 1, wherein molding the channels comprises employing a mold roll that defines headed features in the surface of the channels for mechanically locking the flowable composition in the channels when it stabilizes.

16. The method of claim 1, wherein the channels are formed with varying depths such that the resulting conductive traces are of varying thicknesses.

17. The method of claim 1, wherein the channels are formed with varying widths such that the resulting conductive traces are of varying widths.

18. The method of claim 1, further comprising, prior to filling the channels, surface-treating the channels to promote adhesion of the flowable composition.

19. The method of claim 1, further comprising providing a field of loop-engageable fastener elements on the base exposed to releasably secure the base to a loop-bearing support.

20. The method of claim 19, wherein providing the fastener elements comprises integrally molding the fastener elements with the base such that the fastener elements extend outwards from a surface of the base.

21. The method of claim 1, wherein forming the channels comprises forming the channels with at least a portion whose width decreases with increasing distance from the resin base.

22. The method of claim 1, wherein the pattern of electrically conductive traces is longitudinally continuous and arranged such that, when the base is severed to create individual strips of a desired, finite length between severed ends, the electrically conductive traces provide an electrical connection between the severed ends.

23. The method of claim 22, further comprising forming touch fastener elements exposed along the length of the base and arranged such that the individual strips each have some of the touch fastener elements exposed for releasably mounting the strip to a support surface.

24. The method of claim 1, wherein the pattern of electrically conductive traces form interconnected path segments arranged in accordance with a desired circuit pattern.

25. The method of claim 1, further comprising electroplating a second conductive material onto the conductive traces.

26. The method of claim 1, further comprising attaching an electrically insulating cover over the conductive traces, the cover attached to the base.

27. The method of claim 26, wherein attaching the insulative layer comprises passing the sheet-form base through a gap adjacent a mold roll in the presence of moldable resin to encapsulate the conductive traces.

28. The method of claim 26, wherein attaching the insulative cover comprises spraying an insulating composition onto the base, such that the insulating composition encapsulates the conductive traces.

29. The method of claim 1, wherein the flowable composition contains silver.

30. The method of claim 29, wherein the flowable composition containing silver is a reducible silver composition.

31. A method of forming a releasably securable, flexible conductive strip, the method comprising:
molding a continuous, flexible base of an electrically insulating thermoplastic resin, while forming channels in a surface of the base;
at least partially filling the formed channels with a flowable, electrically conductive composition;
stabilizing the composition in the channels to form a pattern of stable, electrically conductive traces within the channels; and
providing a field of loop-engageable fastener elements on the base and exposed to releasably secure the base to a loop-bearing support.

32. The method of claim 31, wherein the pattern of electrically conductive traces is longitudinally continuous and arranged such that, when the base is severed to create individual strips of a desired, finite length between severed ends, the electrically conductive traces provide an electrical connection between the severed ends.

33. The method of claim 31, further comprising attaching an electrically insulating cover over the conductive traces, the cover attached to the base.

34. A method of forming a flexible circuit, the method comprising:
molding a continuous, flexible base of an electrically insulating thermoplastic resin, while forming channels in a surface of the base;
at least partially filling the formed channels with a flowable, electrically conductive composition;
stabilizing the composition in the channels to form a pattern of stable, electrically conductive traces within the channels;
providing a field of loop-engageable fastener elements on the base and exposed to releasably secured the base to loop-bearing support; and
securing at least one discrete electrical component to the surface of the base, such that the electrical components electrically interconnect a plurality of the traces.

35. The method of claim 34, wherein providing the fastener elements comprises integrally molding the fastener elements with the base such that the fastener elements extend outwards from a surface of the base.
